(19) United States
(12) Patent Application Publication
(10) Pub. No.: US 2018/0035366 A1
(43) Pub. Date: Feb. 1, 2018

(54) SIGNAL DETECTION VERIFICATION

(71) Applicant: QUALCOMM Incorporated, San Diego, CA (US)

(72) Inventors: Mahboobul Alem, Fremont, CA (US); Madhan Jaganathan, Cupertino, CA (US); Benjamin Gibbs, Sunnyvale, CA (US); Suresh Nethirananthan, Cheyyar (IN); Ramachandran Kandasamy, Chennai (IN); Sriharsha Guntanoor, Chennai (IN)

(21) Appl. No.: 15/373,330

(22) Filed: Dec. 8, 2016

(30) Foreign Application Priority Data
Jul. 26, 2016 (IN) 201641025550

(51) Int. Cl. H04W 48/16; H04W 72/04

(52) U.S. Cl. CPC H04W 48/16; H04W 72/04; H04W 84/12

(57) ABSTRACT

Various aspects of the disclosure relate to determining whether a signal detection function is properly detecting for a signal. In an example implementation, the signal detection function detects radar signals. If the signal detection function is not functioning as desired, communication on at least one wireless communication channel may be disabled.

### CROSS-REFERENCE TO RELATED APPLICATION(S)

This application claims priority to and the benefit of India patent application number 201641025550 filed on Jul. 26, 2016, the entire content of which is incorporated herein by reference.

### INTRODUCTION

Various aspects described herein relate to wireless communication, and more particularly but not exclusively, to verifying the efficacy of a signal (e.g., radar) detection function.

Dynamic Frequency Selection (DFS) specifies that Wi-Fi devices using certain 5G channels are to detect the presence of radar in the channel and stop using the channel if radar is found. However, it is possible that a Wi-Fi device could be configured to disable radar detection. For example, a software component of a Wi-Fi device could provide the radar detection function. Thus, someone could disable the radar detection function of a Wi-Fi device by modifying the software code of the Wi-Fi device.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In one aspect, the disclosure provides an apparatus configured for communication that includes a processing system. The processing system is configured to: determine whether radar detection is enabled, and disable communication on at least one wireless communication channel if the determination indicates that radar detection is not enabled.

Another aspect of the disclosure provides a method for communication including: determining whether radar detection is enabled; and disabling communication on at least one wireless communication channel if the determination indicates that radar detection is not enabled.

Another aspect of the disclosure provides an apparatus configured for communication. The apparatus including: means for determining whether radar detection is enabled; and means for disabling communication on at least one wireless communication channel if the determination indicates that radar detection is not enabled.

Another aspect of the disclosure provides a computer-readable medium (e.g., a non-transitory computer-readable medium) storing computer-executable code, including code to: determine whether radar detection is enabled, and disable communication on at least one wireless communication channel if the determination indicates that radar detection is not enabled.

In one aspect, the disclosure provides an access point configured for communication that includes a processing system and a transceiver coupled to the processing system. The processing system is configured to: determine whether radar detection is enabled, and disable communication on at least one wireless communication channel if the determination indicates that radar detection is not enabled. The transceiver is configured to communicate data on the at least one wireless communication channel.

In one aspect, the disclosure provides an access terminal configured for communication that includes a processing system and a user interface coupled to the processing system. The processing system is configured to: determine whether radar detection is enabled, and disable communication on at least one wireless communication channel if the determination indicates that radar detection is not enabled. The user interface is configured to provide data for the communication on the at least one wireless communication channel

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

The accompanying drawings are presented to aid in the description of aspects of the disclosure and are provided solely for illustration of the aspects and not limitations thereof.

FIG. 1 is an example of a wireless communication system in which aspects of the present disclosure may be employed.

FIG. 2 is a layer diagram for DFS in accordance with some aspects of the disclosure.

FIG. 3 is a device architecture in accordance with some aspects of the disclosure.

FIG. 4 is a DFS flow diagram in accordance with some aspects of the disclosure.

FIG. 5 is another DFS flow diagram in accordance with some aspects of the disclosure.

FIG. 6 is a radar pattern table in accordance with some aspects of the disclosure.

FIG. 7 is an example of a wireless communication system in which aspects of the present disclosure may be employed.

FIG. 8 is a functional block diagram of an example apparatus that may be employed within a wireless communication system in accordance with some aspects of the disclosure.

FIG. 9 is a functional block diagram of example components that may be utilized in the apparatus of FIG. 8 to transmit wireless communication.

FIG. 10 is a functional block diagram of example components that may be utilized in the apparatus of FIG. 8 to receive wireless communication.

FIG. 11 is a functional block diagram of an example apparatus in accordance with some aspects of the disclosure.

FIG. 12 is a flow diagram of an example signal detection verification process in accordance with some aspects of the disclosure.

FIG. 13 is a flow diagram of an example signal detection verification process that uses a data pattern in accordance with some aspects of the disclosure.

FIG. 14 is a flow diagram of an example process for triggering signal detection verification in accordance with some aspects of the disclosure.

FIG. 15 is a simplified block diagram of several sample aspects of an apparatus configured with functionality in accordance with some aspects of the disclosure.

FIG. 16 is a simplified block diagram of several sample aspects of a memory configured with code in accordance with some aspects of the disclosure.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim. As an example of the above, in some aspects, a method of communication includes determining whether radar detection is enabled and disabling communication on at least one wireless communication channel if the determination indicates that radar detection is not enabled.

The disclosure relates in some aspects to determining whether a radar detection function is properly detecting for radar. If the radar detection function is not functioning as desired, communication on at least one wireless communication channel may be disabled. For example, communication on a channel that is subject to dynamic frequency selection (DFS) may be disabled to ensure that a device is not interfering with radar operations.

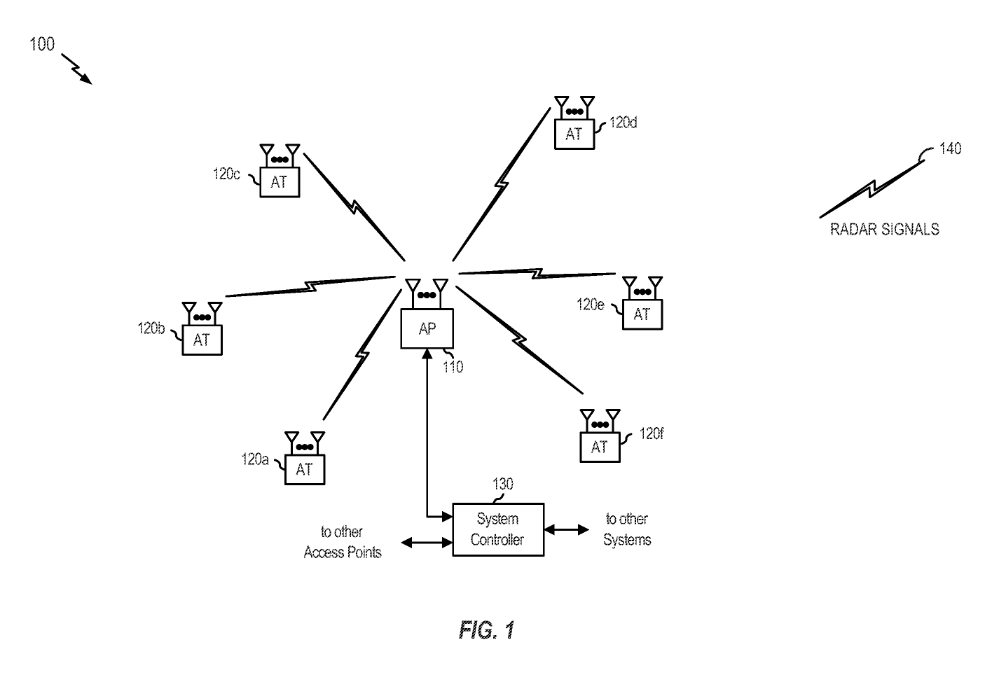

FIG. 1 illustrates a wireless communication system 100 that includes an access point (AP) 110 and several access terminal terminals (ATs) 120. The AP 110 is connected to a system controller 130 to enable communication to other APs and/or other communication systems. It is possible that some of the wireless communication channels that the AP 110 and the ATs 120 use for communication may be used for radar applications (e.g., weather radar). A regulatory body (e.g., the FCC) may require that the wireless system 100 back off of a communication channel if radar signals 140 are detected on that channel.

During normal operation of a wireless access point (AP) in a radar enabled channel, the hardware of the AP scans for potential radar pulses. Firmware of the AP passes the potential radar information to the host of the AP for processing to check against known radar types. If there is a match, the AP moves to another channel and places the channel on a list of channels that must not be used for thirty minutes.

A typical wireless access point (AP) has hardware (HW), firmware (FW), and host software components. In general, AP software may be upgradable to fix bugs or add features and the AP Host software image can be updated by updating the flash memory image.

It is desirable for end-customers to retain the ability to update their AP software from sources other than the original equipment manufacturer (OEM) because they may provide additional features, better security, or the OEM may no longer support the equipment directly. Whereas OEM updates usually remain compliant with all regulatory requirements, 3rd party updates may allow end-users to disable and/or bypass regulatory features such as channel selection, power restrictions, or DFS.

For example, open source code for AP host software may be available for download and modification of the source. End users can use a web-based user interface (UI) to configure an AP and shell/command line tools shipped with the image may be used to configure the AP, fine tune parameters and debug the AP. Thus, it may be possible for anyone to modify the source and disable or bypass radar detection in the AP host software. For example, a user could disable and/or bypass regulatory requirements related to DFS, disable radar detection, and ignore rules regarding a Non-Occupancy List (NOL) after radar detection in a channel.

The disclosure relates in some aspects to using firmware that executes on the radio hardware subsystem to determine whether radar detection is enabled on the AP host during operation. As firmware is typically proprietary and its source code not available to the general public, it is much less likely that firmware could be modified to bypass radar detection. It is also possible for the radio system to authenticate the firmware by checking that it has a known digital signature before execution and reject it if it does not. Thus, compliance of a device can be more effectively assured.

The disclosure relates in some aspects to firmware that sends “spoofed” data that resembles real radar data to the host. The host will match the data with known radar patterns and send a notification of successful radar detection to the firmware. If the firmware does not receive any notification from the host, the firmware concludes that the host software does not meet regulatory requirements for DFS. The firmware will then prevent the host from selecting any of the channels that require radar detection. Thus, in some aspects, hardware and/or firmware may be used to enforce regulatory DFS compliance in user modified or factory certified code, detect if radar detection function is enabled in the AP host software, and detect if NOL compliance is maintained.

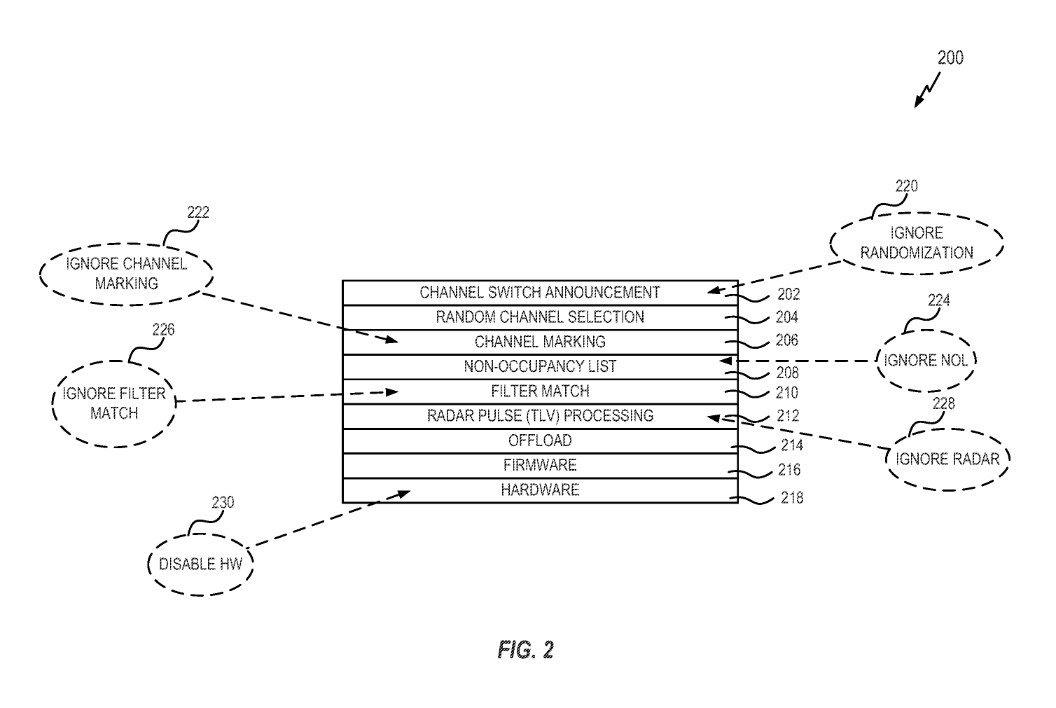

Referring to FIG. 2, there are various points in a set of DFS layers 200 that are susceptible to tampering. In this example, the DFS layers 200 include a channel switch announcement layer 202, a random channel selection layer 204, a channel marking layer 206, a non-occupancy list layer 208, a filter match layer 210, a radar pulse (e.g., type length value) processing layer 212, an offload layer 214, a firmware layer 216, and a hardware layer 218.

Examples of the points in the DFS layers 200 that could be tampered with are indicate in FIG. 2. Firmware could be modified to ignore randomization, 220, ignore channel marking 222, ignore the NOL 224, ignore a filter match 226, ignore radar 228, disable hardware 230, or any combination thereof.

It is desirable for firmware to detect tampering across all layers. To this end, firmware sends a known radar data pattern (spoofed radar) to the host. The sending of this pattern may be triggered or conditioned in different ways in different scenarios. For example, the pattern may be sent: if (or when) Wi-Fi is enabled, if (or when) a DFS channel is selected for the first time, randomly, on-demand, if (or when) a DFS channel is in use, or based on some other condition. The data pattern travels through all the DFS layers 200 and should result in positive detection. Positive detection is reported back to the firmware to confirm all radar detection pieces are functional. Failure to indicate detection means radar detection is not working properly in the host, and the firmware will disregard any host request to select any of the DFS channels. For example, the firmware may reject or ignore a request from the host to select one or more channels (e.g., thereby preventing the device from accessing all of the DFS channel or, in some cases, any of the channels).

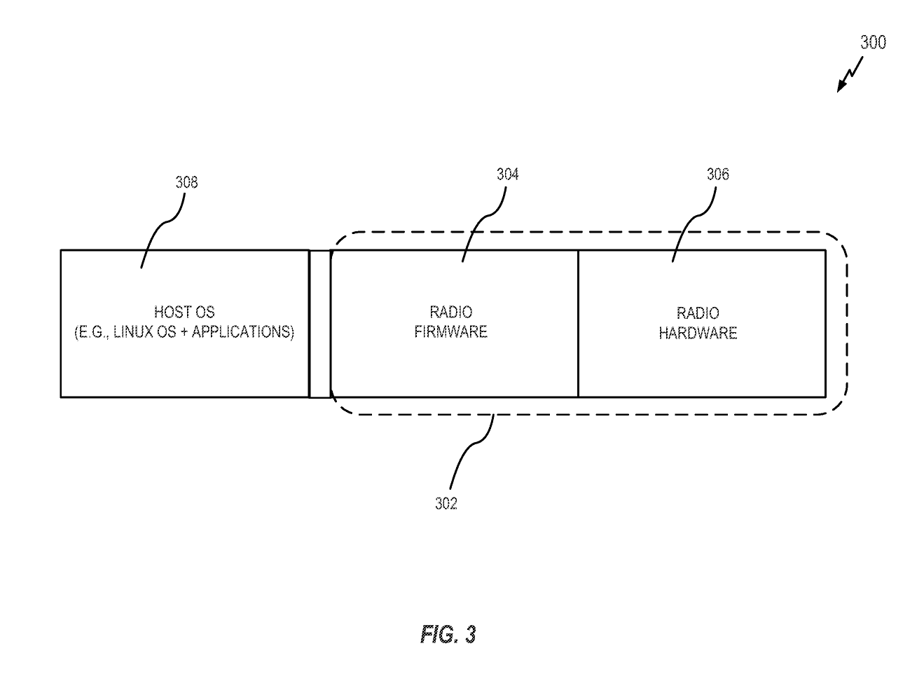

Referring to FIG. 3, a device 300 (e.g., a Wi-Fi device) may contain memory and processing capabilities 302 that run radio firmware 304 on radio hardware 306 and are separate from a host operating system (OS) 308 running host software. In accordance with the teachings herein, the “radio firmware” can run regulatory checks to confirm that the host software is operating in compliance with FCC rules. In particular, the “radio firmware” can verify whether a radar detection function of the host software is operating properly.

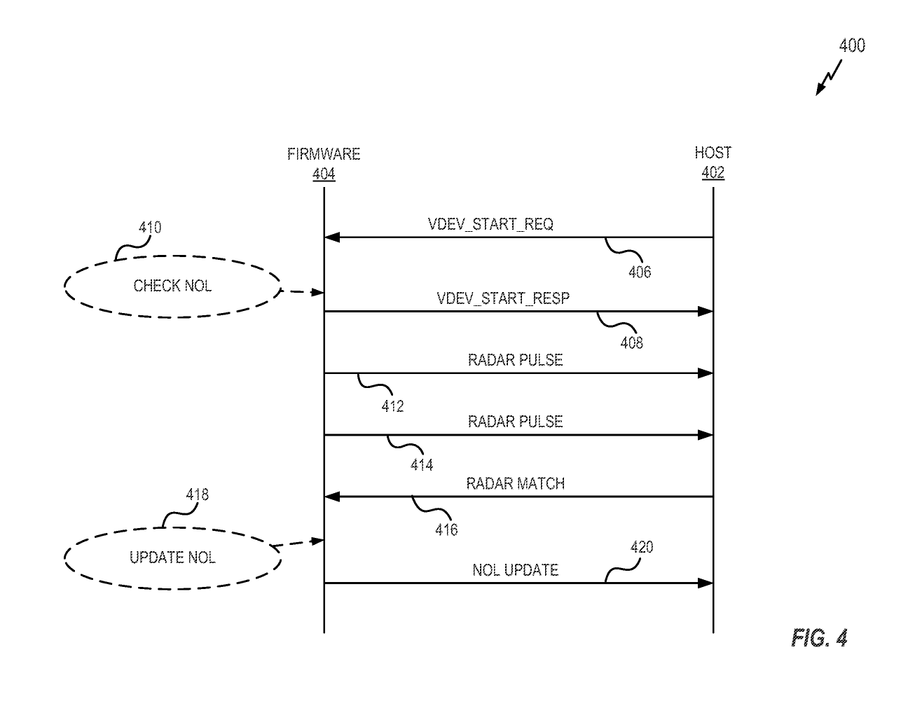

FIG. 4 illustrates an example of a conventional operation for detecting radar. At some point in time, a host 402 (e.g., host software) sends a virtual device (VDEV) start request (VDEV_START_REQ) message 406 to firmware 404 (e.g., radio firmware). The firmware 404 sends a VDEV start response (VDEV_START_RESP) message 408 to the host 402 (e.g., after checking the NOL 410). The firmware 404 then sends potential radar pulse information to the host 402 (e.g., to the host software) via messages 412. Based on this information, the host 402 determines whether the characteristics of the information match the expected characteristics associated with radar. If there is a match, the host 402 informs the firmware that there is radar in the channel of interest (e.g., the current channel) by sending a radar match message 416 to the firmware 404.

A device may maintain a NOL to indicate which DFS channels are currently unavailable. In some implementations, the NOL is managed by the host software. Thus, in this case, the host software updates the NOL in the event communication is not allowed (e.g., due to presence of radar on a channel or a refusal of the firmware to allow communication on a channel).

In other implementations, the firmware manages the NOL (e.g., as shown in FIG. 4). In this case, the firmware will update the NOL 418 (e.g., place channels on the NOL) if a radar event is detected by the host, provide the host with an indication the change in the NOL via an NOL update message 420, and reject any request to use channels on the NOL.

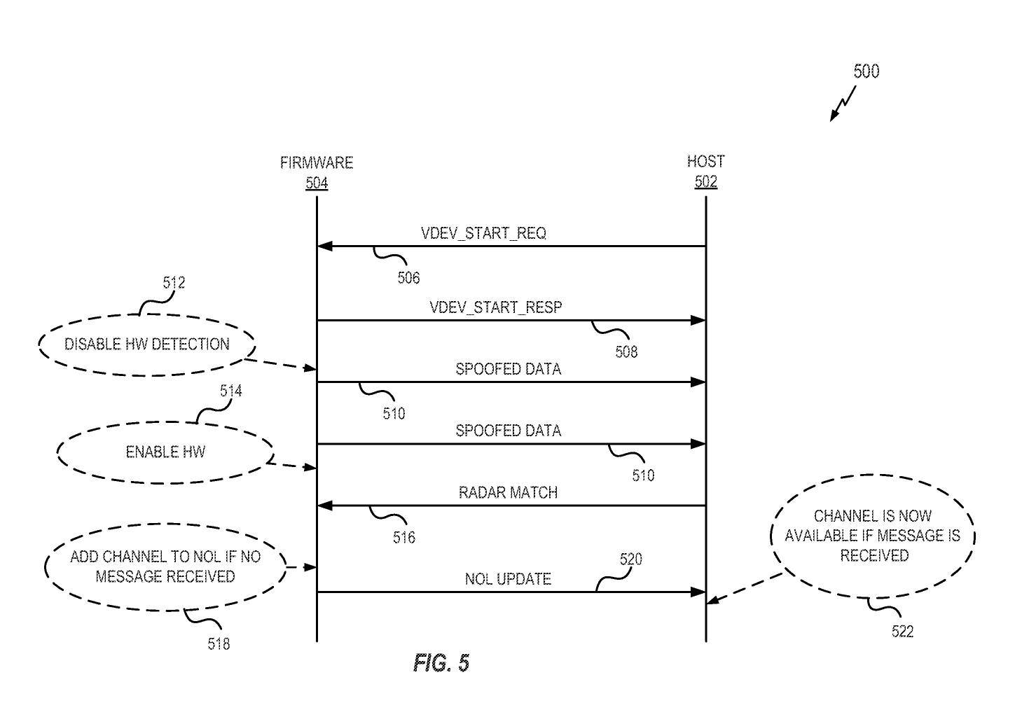

FIG. 5 illustrates an example of a spoof operation 500 for radar detection in accordance with the teachings herein. At some point in time, a host 502 (e.g., host software) sends a virtual device (VDEV) start request (VDEV_START_REQ) message 506 to firmware 504 (e.g., radio firmware). The firmware 504 sends a VDEV start response (VDEV_START_RESP) message 508 to the host 502 (e.g., to the host software).

The firmware 504 then sends spoofed data 510 (e.g., spoof radar pulse information) to the host 502 via messages 412. As indicated, real hardware detection may be disabled 510 while spoofed data is sent. Real hardware detection may then be enabled 514 after all of the spoofed data has been sent.

The host 502 is supposed to determine whether the characteristics of the received information match the expected characteristics associated with radar. If the host 502 reports a radar match (e.g., a radar match message 516), the firmware 504 may be assured that the host 502 is properly checking for the presence of radar. In this case, if applicable, the firmware updates the NOL to indicate that the channel is unavailable. The firmware may choose not to update the NOL if the detection was due to spoofed data.

Otherwise (e.g., if the firmware does not receive the radar match message 516 from the host 592), the firmware 504 may update 518 the NOL to indicate that that the channel (and potentially other channels) is not available because the host cannot be trusted to perform the radar detection function.

Various messages (e.g., between the firmware and the host) may be employed in different implementations. Several example wireless module interface (WMI) messages are set forth below.

WMI_RADAR_FOUND message. Host sends this message to the firmware to indicate that radar was found in the current channel and provides information regarding the characteristics of the radar found. This information may include, for example, frequency (range) where the radar was found, timing (e.g., the time at which a pulse was detected, pulse interval, pulse width, and pulse frequencies. Upon receiving such a message in response to spoof data, the firmware can determine whether the host is adequately testing the data being sent to the host for the presence of radar. In this way, non-operational software or software that was modified to try to trick the firmware (e.g., by acting like radar detection is still functioning) may be detected.

WMI_UPDATE_NOL message. This message (e.g., the NOL update message 520) may be used in implementations where the firmware manages the NOL. The firmware sends this message to the host to indicate a change to NOL. If (e.g., when) radar is found in a channel, the channel is added to NOL. After 30 minutes (or some other designated amount of time), the channel is removed from NOL. This timer may be maintained in the firmware. The firmware may choose not to add a channel to the NOL if the radar found by the host was due to spoofed data. In the event the firmware removes a channel from the NOL and reports this NOL update, the host may thereby determine 522 that the channel is now available for use.

VDEV_START_RESP message. This virtual device (VDEV) message is a response to a request to commence radar detection. This message may include a field to indicate failure to set a channel if the channel is listed in the NOL.

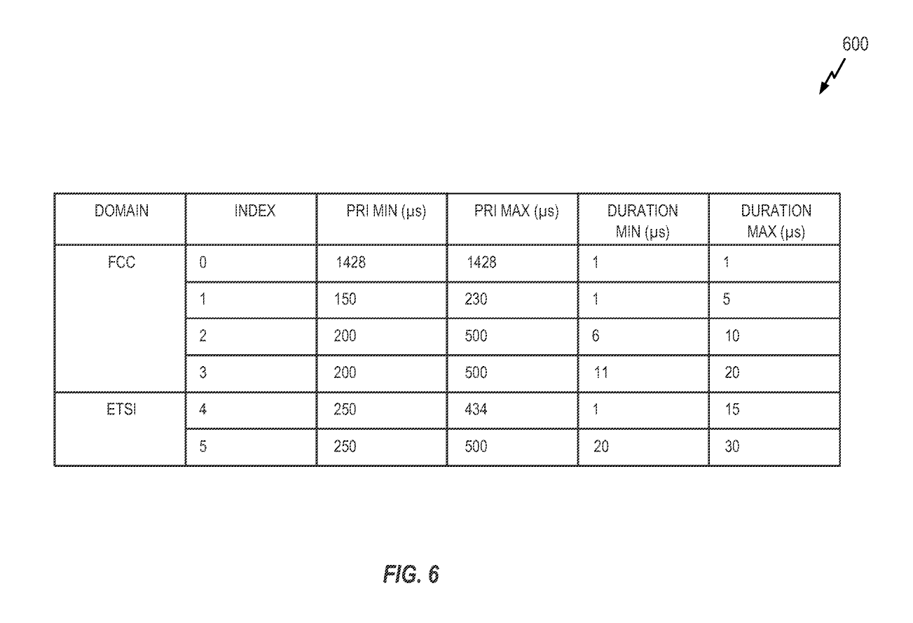

FIG. 6 depicts a table of information 600 that may be used to generate a spoof data pattern. The information is indexed according the different characteristics of the data and corresponding regulatory domains. In some aspects, the spoof data pattern (as with an actual data pattern) may include, for example, information regarding pulse timing (e.g., the time at which a pulse was detected, a pulse interval (e.g., minimum and maximum pulse repetition intervals, PRIs), a pulse width (e.g., minimum and maximum pulse durations in microseconds), and pulse frequencies (e.g., RF band). Here, selection of a radar pattern to spoof may include, for example, selecting a random index, a pulse repetition index (PRI), a duration, and an offset from the table and populating type length values (TLVs) in the radar data pattern. In some implementations, spoofed data is generated from a captured template (e.g., from data derived from real radar signals). Also, the content of the data pattern can vary/change over time.

### Example Wireless Communication System

The teachings herein may be implemented using various wireless technologies and/or various spectra. Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some aspects, wireless signals may be transmitted according to an 802.11 protocol using orthogonal frequency-division multiplexing (OFDM), direct-sequence spread spectrum (DSSS) communication, a combination of OFDM and DSSS communication, or other schemes.

Certain of the devices described herein may further implement Multiple Input Multiple Output (MIMO) technology and be implemented as part of an 802.11 protocol. A MIMO system employs multiple (Nₜ) transmit antennas and multiple (Nᵣ) receive antennas for data transmission. A MIMO channel formed by the Nₜ transmit and Nᵣ receive antennas may be decomposed into Nₛ independent channels, which are also referred to as spatial channels or streams, where Nₛ≦min{Nₜ, Nᵣ}. Each of the Nₛ independent channels corresponds to a dimension. The MIMO system can provide improved performance (e.g., higher throughput and/or greater reliability) if the additional dimensionalities created by the multiple transmit and receive antennas are utilized.

In some implementations, a WLAN includes various devices that access the wireless network. For example, there may be two types of devices: access points (“APs”) and clients (also referred to as stations, or “STAs”). In general, an AP serves as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations, a STA may also be used as an AP.

An access point (“AP”) may also comprise, be implemented as, or known as a Transmit Receive Point (TRP), a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

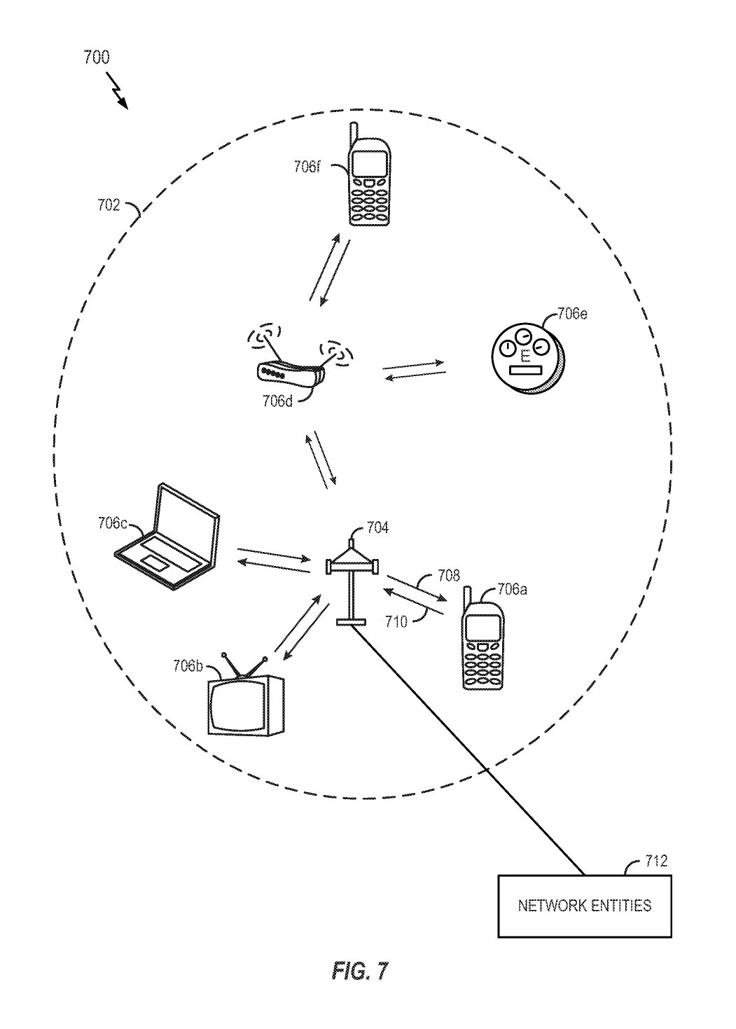

FIG. 7 illustrates an example of a wireless communication system 700 in which aspects of the present disclosure may be employed. The wireless communication system 700 may operate pursuant to a wireless standard, for example the 802.11 standard. The wireless communication system 700 may include an AP 704, which communicates with STAs 706a, 706b, 706c, 706d, 706e, and 706f (collectively STAs 706).

STAs 706e and 706f may have difficulty communicating with the AP 704 or may be out of range and unable to communicate with the AP 704. As such, another STA 706d may be configured as a relay device (e.g., a device comprising STA and AP functionality) that relays communication between the AP 704 and the STAs 706e and 706f.

A variety of processes and methods may be used for transmissions in the wireless communication system 700 between the AP 704 and the STAs 706. For example, signals may be sent and received between the AP 704 and the STAs 706 in accordance with OFDM/OFDMA techniques. If this is the case, the wireless communication system 700 may be referred to as an OFDM/OFDMA system. Alternatively, signals may be sent and received between the AP 704 and the STAs 706 in accordance with CDMA techniques. If this is the case, the wireless communication system 700 may be referred to as a CDMA system.

A communication link that facilitates transmission from the AP 704 to one or more of the STAs 706 may be referred to as a downlink (DL) 708, and a communication link that facilitates transmission from one or more of the STAs 706 to the AP 704 may be referred to as an uplink (UL) 710. Alternatively, a downlink 708 may be referred to as a forward link or a forward channel, and an uplink 710 may be referred to as a reverse link or a reverse channel.

The AP 704 may act as a base station and provide wireless communication coverage in a basic service area (BSA) 702. The AP 704 along with the STAs 706 associated with the AP 704 and that use the AP 704 for communication may be referred to as a basic service set (BSS).

Access points may thus be deployed in a communication network to provide access to one or more services (e.g., network connectivity) for one or more access terminals that may be installed within or that may roam throughout a coverage area of the network. For example, at various points in time an access terminal may connect to the AP 704 or to some other access point in the network (not shown).

Each of the access points may communicate with one or more network entities (represented, for convenience, by network entities 712 in FIG. 7), including each other, to facilitate wide area network connectivity. A network entity may take various forms such as, for example, one or more radio and/or core network entities. Thus, in various implementations the network entities 712 may represent functionality such as at least one of: network management (e.g., via an authentication, authorization, and accounting (AAA) server), session management, mobility management, gateway functions, interworking functions, database functionality, or some other suitable network functionality. Two or more of such network entities may be co-located and/or two or more of such network entities may be distributed throughout a network.

It should be noted that in some implementations the wireless communication system 700 might not have a central AP 704, but rather may function as a peer-to-peer network between the STAs 706. Accordingly, the functions of the AP 704 described herein may alternatively be performed by one or more of the STAs 706. Also, as mentioned above, a relay may incorporate at least some of the functionality of an AP and a STA.

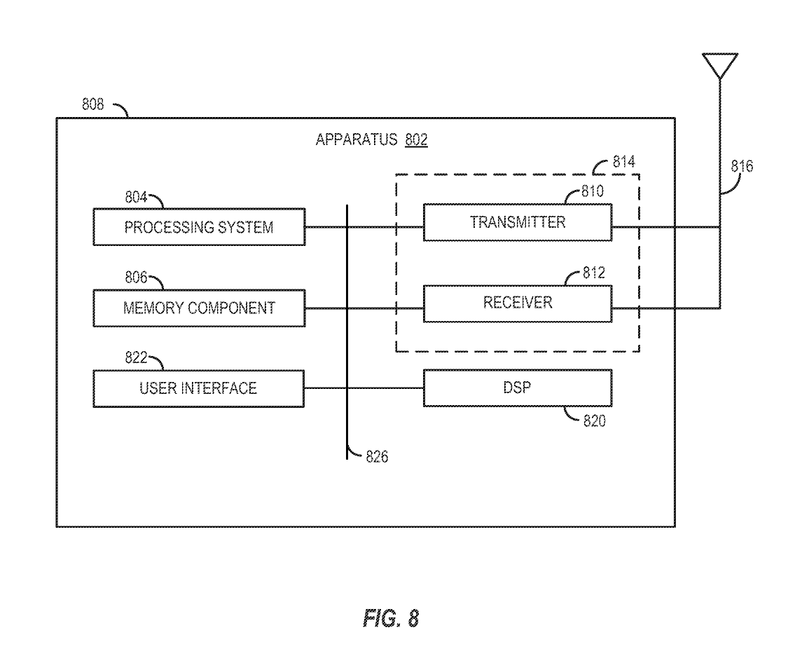

FIG. 8 illustrates various components that may be utilized in an apparatus 802 (e.g., a wireless device) that may be employed within the wireless communication system 700. The apparatus 802 is an example of a device that may be configured to implement the various methods described herein. For example, the apparatus 802 may comprise the AP 704, a relay (e.g., the STA 706d), or one of the STAs 706 of FIG. 7.

The apparatus 802 may include a processing system 804 that controls operation of the apparatus 802. The processing system 804 may also be referred to as a central processing unit (CPU). A memory component 806 (e.g., including a memory device), which may include both read-only memory (ROM) and random access memory (RAM), provides instructions and data to the processing system 804. A portion of the memory component 806 may also include non-volatile random access memory (NVRAM). The processing system 804 typically performs logical and arithmetic operations based on program instructions stored within the memory component 806. The instructions in the memory component 806 may be executable to implement the methods described herein.

If the apparatus 802 is implemented or used as a transmitting node, the processing system 804 may be configured to select one of a plurality of media access control (MAC) header types, and to generate a packet having that MAC header type. For example, the processing system 804 may be configured to generate a packet comprising a MAC header and a payload and to determine what type of MAC header to use.

If the apparatus 802 is implemented or used as a receiving node, the processing system 804 may be configured to process packets of a plurality of different MAC header types. For example, the processing system 804 may be configured to determine the type of MAC header used in a packet and process the packet and/or fields of the MAC header.

The processing system 804 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The apparatus 802 may also include a housing 808 that may include a transmitter 810 and a receiver 812 to allow transmission and reception of data between the apparatus 802 and a remote location. The transmitter 810 and receiver 812 may be combined into single communication device (e.g., a transceiver 814). An antenna 816 may be attached to the housing 808 and electrically coupled to the transceiver 814. The apparatus 802 may also include (not shown) multiple transmitters, multiple receivers, multiple transceivers, and/or multiple antennas. A transmitter 810 and a receiver 812 may comprise an integrated device (e.g., embodied as a transmitter circuit and a receiver circuit of a single communication device) in some implementations, may comprise a separate transmitter device and a separate receiver device in some implementations, or may be embodied in other ways in other implementations.

The transmitter 810 may be configured to wirelessly transmit packets having different MAC header types. For example, the transmitter 810 may be configured to transmit packets with different types of headers generated by the processing system 804, discussed above.

The receiver 812 may be configured to wirelessly receive packets having different MAC header type. In some aspects, the receiver 812 is configured to detect a type of a MAC header used and process the packet accordingly.

The receiver 812 may be used to detect and quantify the level of signals received by the transceiver 814. The receiver 812 may detect such signals as total energy, energy per subcarrier per symbol, power spectral density and other signals. The apparatus 802 may also include a digital signal processor (DSP) 820 for use in processing signals. The DSP 820 may be configured to generate a data unit for transmission. In some aspects, the data unit may comprise a physical layer data unit (PPDU). In some aspects, the PPDU is referred to as a packet.

The apparatus 802 may further comprise a user interface 822 in some aspects. The user interface 822 may comprise a keypad, a microphone, a speaker, and/or a display. The user interface 822 may include any element or component that conveys information to a user of the apparatus 802 and/or receives input from the user.

The various components of the apparatus 802 may be coupled together by a bus system 826. The bus system 826 may include a data bus, for example, as well as a power bus, a control signal bus, and a status signal bus in addition to the data bus. Those of skill in the art will appreciate the components of the apparatus 802 may be coupled together or accept or provide inputs to each other using some other mechanism.

Although a number of separate components are illustrated in FIG. 8, one or more of the components may be combined or commonly implemented. For example, the processing system 804 may be used to implement not only the functionality described above with respect to the processing system 804, but also to implement the functionality described above with respect to the transceiver 814 and/or the DSP 820. Further, each of the components illustrated in FIG. 8 may be implemented using a plurality of separate elements. Furthermore, the processing system 804 may be used to implement any of the components, modules, circuits, or the like described below, or each may be implemented using a plurality of separate elements.

For ease of reference, if the apparatus 802 is configured as a transmitting node, it is hereinafter referred to as an apparatus 802t. Similarly, if the apparatus 802 is configured as a receiving node, it is hereinafter referred to as an apparatus 802r. A device in the wireless communication system 700 may implement only functionality of a transmitting node, only functionality of a receiving node, or functionality of both a transmitting node and a receive node.

As discussed above, the apparatus 802 may comprise an AP 704 or a STA 706, and may be used to transmit and/or receive communication having a plurality of MAC header types.

The components of FIG. 8 may be implemented in various ways. In some implementations, the components of FIG. 8 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks of FIG. 8 may be implemented by processor and memory component(s) of the apparatus (e.g., by execution of appropriate code and/or by appropriate configuration of processor components). It should be appreciated that these components may be implemented in different types of apparatuses in different implementations (e.g., in an ASIC, in a system-on-a-chip (SoC), etc.).

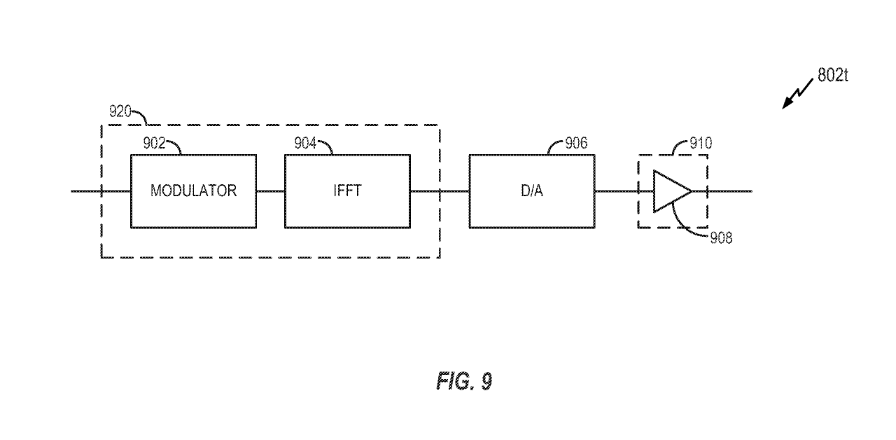

As discussed above, the apparatus 802 may comprise an AP 704 or a STA 706, a relay, or some other type of apparatus, and may be used to transmit and/or receive communication. FIG. 9 illustrates various components that may be utilized in the apparatus 802t to transmit wireless communication. The components illustrated in FIG. 9 may be used, for example, to transmit OFDM communication. In some aspects, the components illustrated in FIG. 9 are used to generate and transmit packets to be sent over a bandwidth of less than or equal to 1 MHz.

The apparatus 802t of FIG. 9 may comprise a modulator 902 configured to modulate bits for transmission. For example, the modulator 902 may determine a plurality of symbols from bits received from the processing system 804 (FIG. 8) or the user interface 822 (FIG. 8), for example by mapping bits to a plurality of symbols according to a constellation. The bits may correspond to user data or to control information. In some aspects, the bits are received in codewords. In one aspect, the modulator 902 may comprise a QAM (quadrature amplitude modulation) modulator, for example, a 16-QAM modulator or a 64-QAM modulator. In other aspects, the modulator 902 may comprise a binary phase-shift keying (BPSK) modulator, a quadrature phase-shift keying (QPSK) modulator, or an 8-PSK modulator.

The apparatus 802t may further comprise a transform module 904 configured to convert symbols or otherwise modulated bits from the modulator 902 into a time domain. In FIG. 9, the transform module 904 is illustrated as being implemented by an inverse fast Fourier transform (IFFT) module. In some implementations, there may be multiple transform modules (not shown) that transform units of data of different sizes. In some implementations, the transform module 904 may be itself configured to transform units of data of different sizes. For example, the transform module 904 may be configured with a plurality of modes, and may use a different number of points to convert the symbols in each mode. For example, the IFFT may have a mode where 32 points are used to convert symbols being transmitted over 32 tones (i.e., subcarriers) into a time domain, and a mode where 64 points are used to convert symbols being transmitted over 64 tones into a time domain. The number of points used by the transform module 904 may be referred to as the size of the transform module 904.

In FIG. 9, the modulator 902 and the transform module 904 are illustrated as being implemented in the DSP 920. In some aspects, however, one or both of the modulator 902 and the transform module 904 are implemented in the processing system 804 or in another element of the apparatus 802t (e.g., see description above with reference to FIG. 8).

As discussed above, the DSP 920 may be configured to generate a data unit for transmission. In some aspects, the modulator 902 and the transform module 904 may be configured to generate a data unit comprising a plurality of fields including control information and a plurality of data symbols.

Returning to the description of FIG. 9, the apparatus 802t may further comprise a digital to analog converter 906 configured to convert the output of the transform module into an analog signal. For example, the time-domain output of the transform module 904 may be converted to a baseband OFDM signal by the digital to analog converter 906. The digital to analog converter 906 may be implemented in the processing system 804 or in another element of the apparatus 802 of FIG. 8. In some aspects, the digital to analog converter 906 is implemented in the transceiver 814 (FIG. 8) or in a data transmit processor.

The analog signal may be wirelessly transmitted by the transmitter 910. The analog signal may be further processed before being transmitted by the transmitter 910, for example by being filtered or by being upconverted to an intermediate or carrier frequency. In the aspect illustrated in FIG. 9, the transmitter 910 includes a transmit amplifier 908. Prior to being transmitted, the analog signal may be amplified by the transmit amplifier 908. In some aspects, the amplifier 908 comprises a low noise amplifier (LNA).

The transmitter 910 is configured to transmit one or more packets or data units in a wireless signal based on the analog signal. The data units may be generated using the processing system 804 (FIG. 8) and/or the DSP 920, for example using the modulator 902 and the transform module 904 as discussed above. Data units that may be generated and transmitted as discussed above are described in additional detail below.

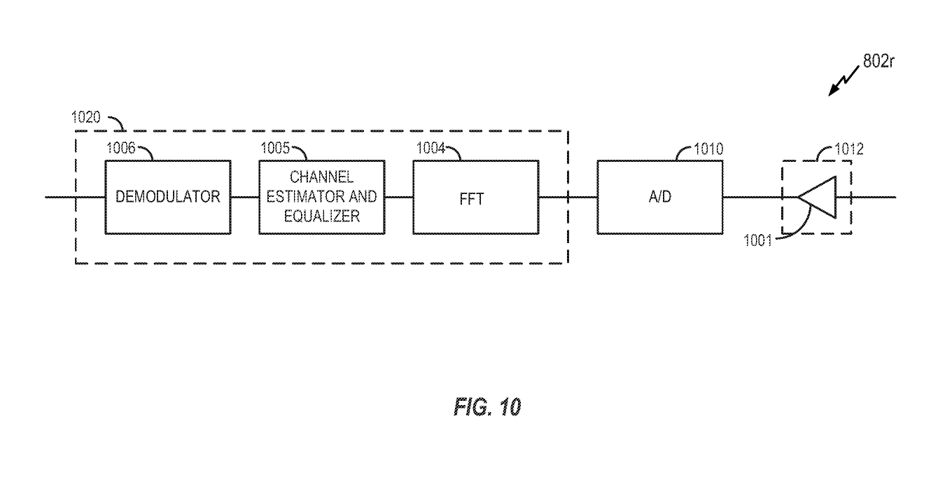

FIG. 10 illustrates various components that may be utilized in the apparatus 802 of FIG. 8 to receive wireless communication. The components illustrated in FIG. 10 may be used, for example, to receive OFDM communication. For example, the components illustrated in FIG. 10 may be used to receive data units transmitted by the components discussed above with respect to FIG. 9.

The receiver 1012 of apparatus 802r is configured to receive one or more packets or data units in a wireless signal. Data units that may be received and decoded or otherwise processed as discussed below.

In the aspect illustrated in FIG. 10, the receiver 1012 includes a receive amplifier 1001. The receive amplifier 1001 may be configured to amplify the wireless signal received by the receiver 1012. In some aspects, the receiver 1012 is configured to adjust the gain of the receive amplifier 1001 using an automatic gain control (AGC) procedure. In some aspects, the automatic gain control uses information in one or more received training fields, such as a received short training field (STF) for example, to adjust the gain. Those having ordinary skill in the art will understand methods for performing AGC. In some aspects, the amplifier 1001 comprises an LNA.

The apparatus 802r may comprise an analog to digital converter 1010 configured to convert the amplified wireless signal from the receiver 1012 into a digital representation thereof. Further to being amplified, the wireless signal may be processed before being converted by the analog to digital converter 1010, for example by being filtered or by being downconverted to an intermediate or baseband frequency. The analog to digital converter 1010 may be implemented in the processing system 804 (FIG. 8) or in another element of the apparatus 802r. In some aspects, the analog to digital converter 1010 is implemented in the transceiver 814 (FIG. 8) or in a data receive processor.

The apparatus 802r may further comprise a transform module 1004 configured to convert the representation of the wireless signal into a frequency spectrum. In FIG. 10, the transform module 1004 is illustrated as being implemented by a fast Fourier transform (FFT) module. In some aspects, the transform module may identify a symbol for each point that it uses. As described above with reference to FIG. 9, the transform module 1004 may be configured with a plurality of modes, and may use a different number of points to convert the signal in each mode. The number of points used by the transform module 1004 may be referred to as the size of the transform module 1004. In some aspects, the transform module 1004 may identify a symbol for each point that it uses.

The apparatus 802r may further comprise a channel estimator and equalizer 1005 configured to form an estimate of the channel over which the data unit is received, and to remove certain effects of the channel based on the channel estimate. For example, the channel estimator and equalizer 1005 may be configured to approximate a function of the channel, and the channel equalizer may be configured to apply an inverse of that function to the data in the frequency spectrum.

The apparatus 802r may further comprise a demodulator 1006 configured to demodulate the equalized data. For example, the demodulator 1006 may determine a plurality of bits from symbols output by the transform module 1004 and the channel estimator and equalizer 1005, for example by reversing a mapping of bits to a symbol in a constellation. The bits may be processed or evaluated by the processing system 804 (FIG. 8), or used to display or otherwise output information to the user interface 822 (FIG. 8). In this way, data and/or information may be decoded. In some aspects, the bits correspond to codewords. In one aspect, the demodulator 1006 comprises a QAM (quadrature amplitude modulation) demodulator, for example an 8-QAM demodulator or a 64-QAM demodulator. In other aspects, the demodulator 1006 comprises a binary phase-shift keying (BPSK) demodulator or a quadrature phase-shift keying (QPSK) demodulator.

In FIG. 10, the transform module 1004, the channel estimator and equalizer 1005, and the demodulator 1006 are illustrated as being implemented in the DSP 1020. In some aspects, however, one or more of the transform module 1004, the channel estimator and equalizer 1005, and the demodulator 1006 are implemented in the processing system 804 (FIG. 8) or in another element of the apparatus 802 (FIG. 8).

As discussed above, the wireless signal received at the receiver 812 comprises one or more data units. Using the functions or components described above, the data units or data symbols therein may be decoded evaluated or otherwise evaluated or processed. For example, the processing system 804 (FIG. 8) and/or the DSP 1020 may be used to decode data symbols in the data units using the transform module 1004, the channel estimator and equalizer 1005, and the demodulator 1006.

Data units exchanged by the AP 704 and the STA 706 may include control information or data, as discussed above. At the physical (PHY) layer, these data units may be referred to as physical layer protocol data units (PPDUs). In some aspects, a PPDU may be referred to as a packet or physical layer packet. Each PPDU may comprise a preamble and a payload. The preamble may include training fields and a SIG field. The payload may comprise a Media Access Control (MAC) header or data for other layers, and/or user data, for example. The payload may be transmitted using one or more data symbols. The systems, methods, and devices herein may utilize data units with training fields whose peak-to-power ratio has been minimized.

The apparatus 802t shown in FIG. 9 is an example of a single transmit chain used for transmitting via an antenna. The apparatus 802r shown in FIG. 10 is an example of a single receive chain used for receiving via an antenna. In some implementations, the apparatus 802t or 802r may implement a portion of a MIMO system using multiple antennas to simultaneously transmit data.

The wireless communication system 700 may employ methods to allow efficient access of the wireless medium based on unpredictable data transmissions while avoiding collisions. As such, in accordance with various aspects, the wireless communication system 700 performs carrier sense multiple access/collision avoidance (CSMA/CA) that may be referred to as the Distributed Coordination Function (DCF). More generally, an apparatus 802 having data for transmission senses the wireless medium to determine if the channel is already occupied. If the apparatus 802 senses the channel is idle, then the apparatus 802 transmits prepared data. Otherwise, the apparatus 802 may defer for some period before determining again whether or not the wireless medium is free for transmission. A method for performing CSMA may employ various gaps between consecutive transmissions to avoid collisions. In an aspect, transmissions may be referred to as frames and a gap between frames is referred to as an Interframe Spacing (IFS). Frames may be any one of user data, control frames, management frames, and the like.

IFS time durations may vary depending on the type of time gap provided. Some examples of IFS include a Short Interframe Spacing (SIFS), a Point Interframe Spacing (PIFS), and a DCF Interframe Spacing (DIFS) where SIFS is shorter than PIFS, which is shorter than DIFS. Transmissions following a shorter time duration will have a higher priority than one that must wait longer before attempting to access the channel.

A wireless apparatus may include various components that perform functions based on signals that are transmitted by or received at the wireless apparatus. For example, in some implementations a wireless apparatus comprises a user interface configured to output an indication based on a received signal as taught herein.

A wireless apparatus as taught herein may communicate via one or more wireless communication links that are based on or otherwise support any suitable wireless communication technology. For example, in some aspects a wireless apparatus may associate with a network such as a local area network (e.g., a Wi-Fi network) or a wide area network. To this end, a wireless apparatus may support or otherwise use one or more of a variety of wireless communication technologies, protocols, or standards such as, for example, Wi-Fi, WiMAX, CDMA, TDMA, OFDM, and OFDMA. Also, a wireless apparatus may support or otherwise use one or more of a variety of corresponding modulation or multiplexing schemes. A wireless apparatus may thus include appropriate components (e.g., air interfaces) to establish and communicate via one or more wireless communication links using the above or other wireless communication technologies. For example, a device may comprise a wireless transceiver with associated transmitter and receiver components that may include various components (e.g., signal generators and signal processors) that facilitate communication over a wireless medium.

The teachings herein may be incorporated into (e.g., implemented within or performed by) a variety of apparatuses (e.g., nodes). In some aspects, an apparatus (e.g., a wireless apparatus) implemented in accordance with the teachings herein may comprise an access point, a relay, or an access terminal.

An access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

A relay may comprise, be implemented as, or known as a relay node, a relay device, a relay station, a relay apparatus, or some other similar terminology. As discussed above, in some aspects, a relay may comprise some access terminal functionality and some access point functionality.

In some aspects, a wireless apparatus comprises an access device (e.g., an access point) for a communication system. Such an access device provides, for example, connectivity to another network (e.g., a wide area network such as the Internet or a cellular network) via a wired or wireless communication link. Accordingly, the access device enables another device (e.g., a wireless station) to access the other network or some other functionality. In addition, it should be appreciated that one or both of the devices may be portable or, in some cases, relatively non-portable. Also, it should be appreciated that a wireless apparatus also may be capable of transmitting and/or receiving information in a non-wireless manner (e.g., via a wired connection) via an appropriate communication interface.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communication (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3^{rd} Generation Partnership Project” (3GPP), while cdma2000 is described in documents from an organization named “3^{rd} Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1×RTT, 1×EV-DO Rel0, RevA, RevB) technology and other technologies.

### Example Communication Device

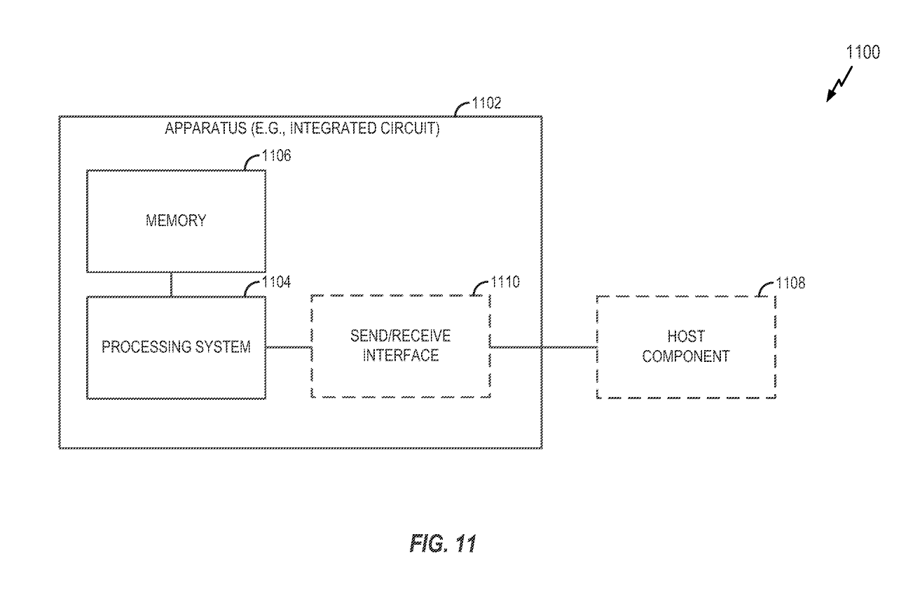

FIG. 11 illustrates an example communication device 1100 (e.g., an AP, an AT, or some other type of device) according to certain aspects of the disclosure. The communication device 1100 includes an apparatus 1102 (e.g., an integrated circuit). In some aspects, the apparatus 1102 may be configured to operate in a wireless communication node (e.g., the AP 110 or an AT 120 of FIG. 1) and to perform one or more of the operations described herein. For convenience, a wireless communication node (e.g., an AP, and AT, a relay, etc.) may be referred to as a wireless node. The apparatus 1102 includes a processing system 1104, and a memory 1106 coupled to the processing system 1104. Example implementations of the processing system 1104 are provided herein. In some aspects, the processing system 1104 and the memory 1106 of FIG. 11 may correspond to the processing system 804 and the memory component 806 of FIG. 8.

The processing system 1104 is generally adapted for processing, including the execution of such programming stored on the memory 1106. For example, the memory 1106 may store instructions that, when executed by the processing system 1104, cause the processing system 1104 to perform one or more of the operations described herein. As used herein, the terms “programming” or “instructions” or “code” shall be construed broadly to include without limitation instruction sets, instructions, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise. In some implementations, the apparatus 1102 provides the firmware functionality and the host functionality as discussed herein. In some aspects, one or more of any components represented by dashed boxes in FIG. 11 may be optional.

In some implementations, the apparatus 1102 communicates with another component (i.e., a component external to the apparatus 1102) of the communication device 1100. For example, in some implementations, the apparatus 1102 provides the firmware functionality discussed herein and communicates with an external host component 1108 of the communication device 1100. In this case, the host component 1108 provides the host functionality as discussed herein. To this end, in some implementations, the apparatus 1102 may include a send/receive interface 1110 (e.g., an interface bus, bus drivers, bus receivers, or other suitable circuitry) coupled to the processing system 1104 for sending information (e.g., radar data patterns, messages, etc.) between the processing system 1104 and the host component 1108. In some implementations, the interface 1110 may be configured to interface the processing system 1104 to one or more other components (e.g., a radio frequency (RF) front end (e.g., a transmitter and/or a receiver)) of the communication device 1100 (other components not shown in FIG. 11).

The apparatus 1102 may communicate with other apparatuses in various ways. In cases where the apparatus 1102 include an RF transceiver (not shown in FIG. 11), the apparatus may transmit and receive information (e.g. a frame, a message, bits, etc.) via RF signaling. In some cases, rather than transmitting information via RF signaling, the apparatus 1102 may have an interface to provide (e.g., output, send, transmit, etc.) information for RF transmission. For example, the processing system may output information, via a bus interface, to an RF front end for RF transmission. Similarly, rather than receiving information via RF signaling, the apparatus 1102 may have an interface to obtain information that is received by another apparatus. For example, the processing system may obtain (e.g., receive) information, via a bus interface, from an RF receiver that received the information via RF signaling.

### Example Processes

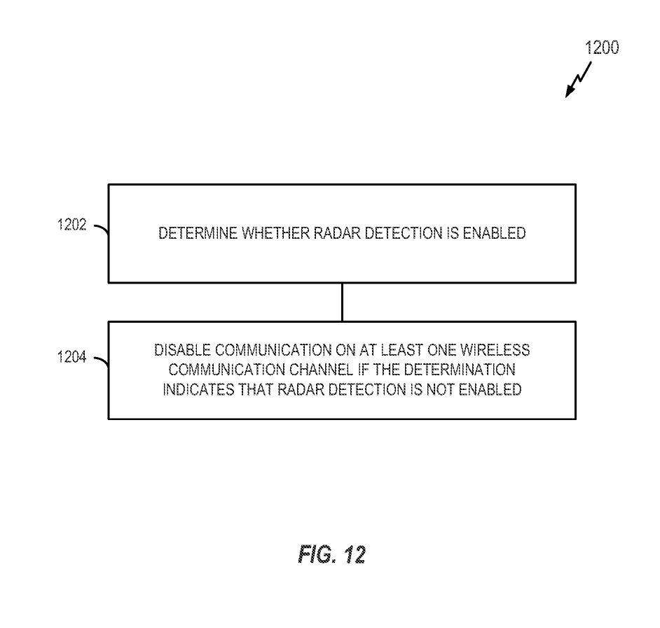

FIG. 12 illustrates a process 1200 for communication in accordance with some aspects of the disclosure. The process 1200 may take place within a processing system (e.g., the processing system 1104 of FIG. 11), which may be located in an AP, an AT, or some other suitable apparatus. Of course, in various aspects within the scope of the disclosure, the process 1200 may be implemented by any suitable apparatus capable of supporting communication-related operations.

At block 1202, an apparatus (e.g., an access point) determines whether radar detection is enabled. For example, the apparatus may provide a data pattern indicative of a radar signal for transmission to a component of the apparatus designated to perform a radar detection function, and then determine whether a response to the data is received from the component.

At block 1204, the apparatus disables communication on at least one wireless communication channel if the determination indicates that radar detection is not enabled. For example, the apparatus may ignore or reject a request to select the at least one communication channel.

The disabling may take various forms. In some aspects, the disabling of communication on the at least one wireless communication channel may include blocking the component from using the at least one wireless communication channel. In some aspects, the disabling of communication on the at least one wireless communication channel may include ignoring a request to select the at least one communication channel. In some aspects, the disabling of communication on the at least one wireless communication channel may include rejecting a request to select the at least one communication channel.

In some aspects, the at least one wireless communication channel may be associated with a radar detection requirement. For example, the at least one wireless communication channel may be a dynamic frequency selection channel.

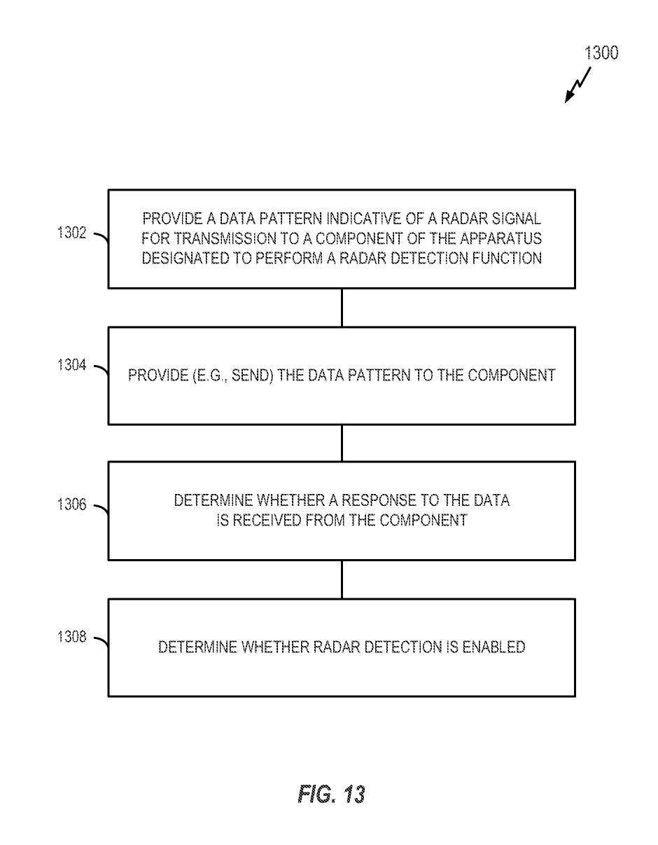

FIG. 13 illustrates a process 1300 for communication in accordance with some aspects of the disclosure. In some aspects, the process 1300 may be used in conjunction with (e.g., in addition to or as part of) the process 1200 of FIG. 12. The process 1300 may take place within a processing system (e.g., the processing system 1104 of FIG. 11), which may be located in an AP, an AT, or some other suitable apparatus. Of course, in various aspects within the scope of the disclosure, the process 1300 may be implemented by any suitable apparatus capable of supporting communication-related operations.

At block 1302, an apparatus (e.g., an access point) provides a data pattern indicative of a radar signal for transmission to a component of the apparatus designated to perform a radar detection function. In some aspects, the data pattern may be a spoofed data pattern.

The data pattern may be provided in various ways. In some aspects, the apparatus may provide different data patterns indicative of different radar signals to the component over time. In some aspects, the apparatus may provide the data pattern randomly. In some aspects, the apparatus may provide the data pattern periodically. In some aspects, the apparatus may provide the data pattern on demand. In some aspects, the apparatus may provide the data pattern if Wi-Fi communication is enabled. In some aspects, the apparatus may provide the data pattern for a channel if the channel is in use. Thus, to provide the data pattern, the apparatus may perform at least one of: provide the data pattern on a random basis, provide the data pattern on a periodic basis, provide the data pattern on an on-demand basis, provide the data pattern if Wi-Fi communication is enabled, provide the data pattern for a channel if the channel is in use, or any combination thereof.

At block 1304, the apparatus provides the data pattern to the component. For example, an interface of the apparatus may output a signal including the data pattern to the component. In some aspects, the component may be a host software component of the apparatus and the data pattern may be sent by a firmware component of the apparatus.

At block 1306, the apparatus determines whether a response to the data pattern is received from the component. In some aspects, the response may include an indication of whether radar is present.

At block 1308, the apparatus determines whether radar detection is enabled based, at least in part, on the determination of block 1306. For example, the determination of whether radar detection is enabled may be based on the indication of whether radar is present.

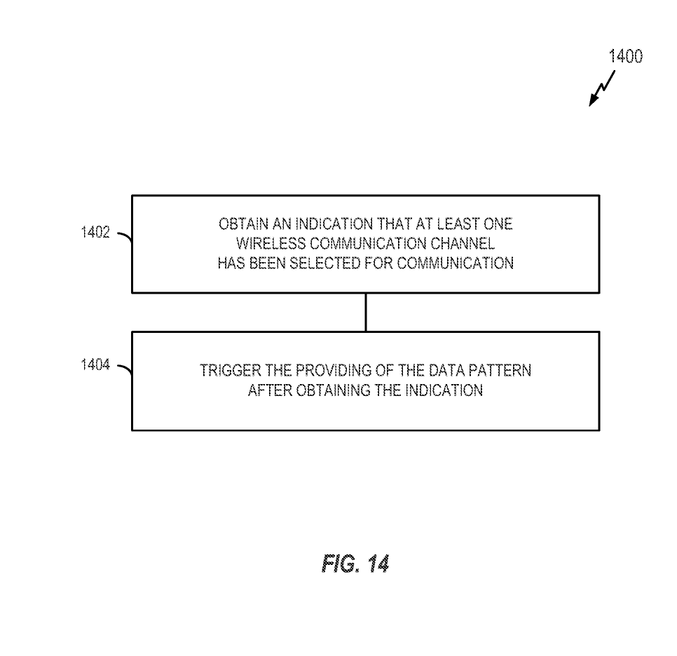

FIG. 14 illustrates a process 1400 for communication in accordance with some aspects of the disclosure. In some aspects, the process 1400 may be used in conjunction with (e.g., in addition to or as part of) the process 1200 of FIG. 12. The process 1400 may take place within a processing system (e.g., the processing system 1104 of FIG. 11), which may be located in an AP, an AT, or some other suitable apparatus. Of course, in various aspects within the scope of the disclosure, the process 1400 may be implemented by any suitable apparatus capable of supporting communication-related operations.

At block 1402, an apparatus (e.g., an access point) obtains an indication that at least one wireless communication channel has been selected for communication. For example, a firmware component may receive an indication from a host component that communication will commence on a DFS channel or that a DFS channel is in use. As another example, host software may sends a virtual device start request message to radio firmware indicating the channel or channels to be used.

At block 1404, the apparatus triggers the providing of the data pattern after obtaining the indication. For example, upon determining that the indication has been received, radio firmware may determine whether the channel is a DFS channel and, if so, invoke the process 1300 of FIG. 13.

In some aspects, an apparatus may perform any combination of the operations described above for FIGS. 12-14.

### Example Apparatus

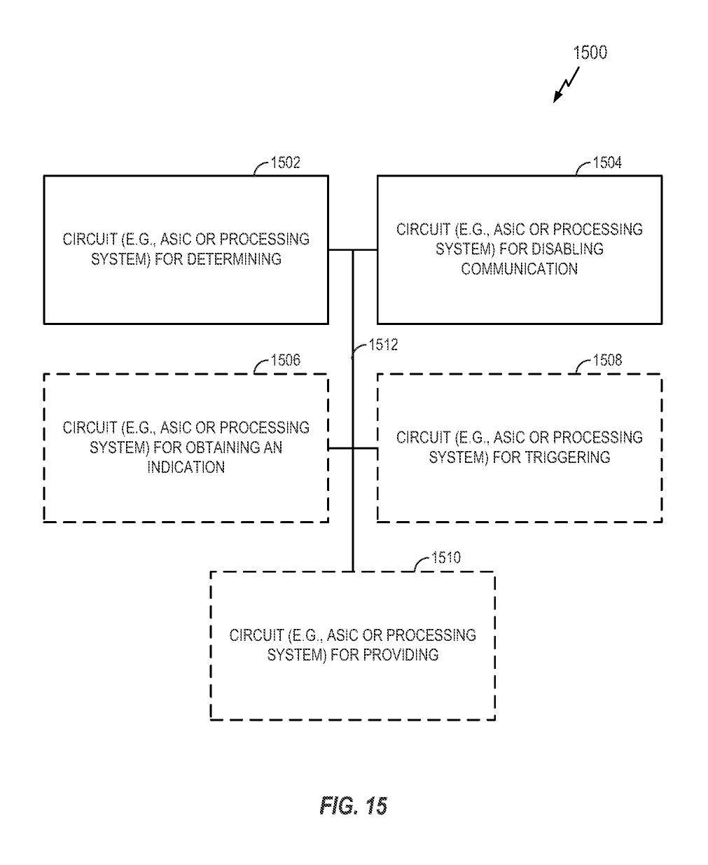

The components described herein may be implemented in a variety of ways. Referring to FIG. 15, an apparatus 1500 is represented as a series of interrelated functional blocks that represent functions implemented by, for example, one or more integrated circuits (e.g., an ASIC) or implemented in some other manner as taught herein. As discussed herein, an integrated circuit may include a processor, software, other components, or some combination thereof.

The apparatus 1500 includes one or more modules that may perform one or more of the functions described above with regard to various figures. For example, a circuit (e.g., an ASIC or a processing system) for determining 1502 may correspond to, for example, a processing system as discussed herein. A circuit (e.g., an ASIC or a processing system) for disabling communication 1504 may correspond to, for example, a processing system and/or a transceiver as discussed herein. A circuit (e.g., an ASIC or a processing system) for obtaining an indication 1506 may correspond to, for example, a processing system as discussed herein. A circuit (e.g., an ASIC or a processing system) for triggering 1508 may correspond to, for example, a processing system as discussed herein. A circuit (e.g., an ASIC or a processing system) for providing 1510 may correspond to, for example, an interface or a transmitter as discussed herein.

As noted above, in some aspects these modules may be implemented via appropriate processor components. These processor components may in some aspects be implemented, at least in part, using structure as taught herein. In some aspects, a processor may be configured to implement a portion or all of the functionality of one or more of these modules. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. In some aspects, one or more of any components represented by dashed boxes in FIG. 15 may be optional.

As noted above, the apparatus 1500 comprises one or more integrated circuits in some implementations. For example, in some aspects a single integrated circuit implements the functionality of one or more of the illustrated components, while in other aspects more than one integrated circuit implements the functionality of one or more of the illustrated components. As one specific example, the apparatus 1500 may comprise a single device (e.g., with components 1502-1510 comprising different sections of an ASIC). As another specific example, the apparatus 1500 may comprise several devices (e.g., with the components 1502-1508 comprising one ASIC, and the component 1510 comprising another ASIC).

In addition, the components and functions represented by FIG. 15 as well as other components and functions described herein, may be implemented using any suitable means. Such means are implemented, at least in part, using corresponding structure as taught herein. For example, the components described above in conjunction with the “ASIC for” components of FIG. 15 correspond to similarly designated “means for” functionality. Thus, one or more of such means is implemented using one or more of processor components, integrated circuits, or other suitable structure as taught herein in some implementations.

The various operations of methods described herein may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar functionality and/or numbering. For example, the blocks of the processes 1200-1400 illustrated in FIGS. 12-14 may correspond at least in some aspects, to corresponding blocks of the apparatus 1500 illustrated in FIG. 15. For example, a means for determining whether radar detection is enabled may be the circuit for determining 1502, a means for disabling communication on at least one wireless communication channel if the determination indicates that radar detection is not enabled may be the circuit for disabling communication 1504, a means for obtaining an indication that the at least one wireless communication channel has been selected for communication may be the circuit for obtaining 1506, a means for triggering the providing of the data pattern after obtaining the indication may be the circuit for triggering 1508, or a means for providing the data pattern to the component may be the circuit for providing 1510.

### Example Programming

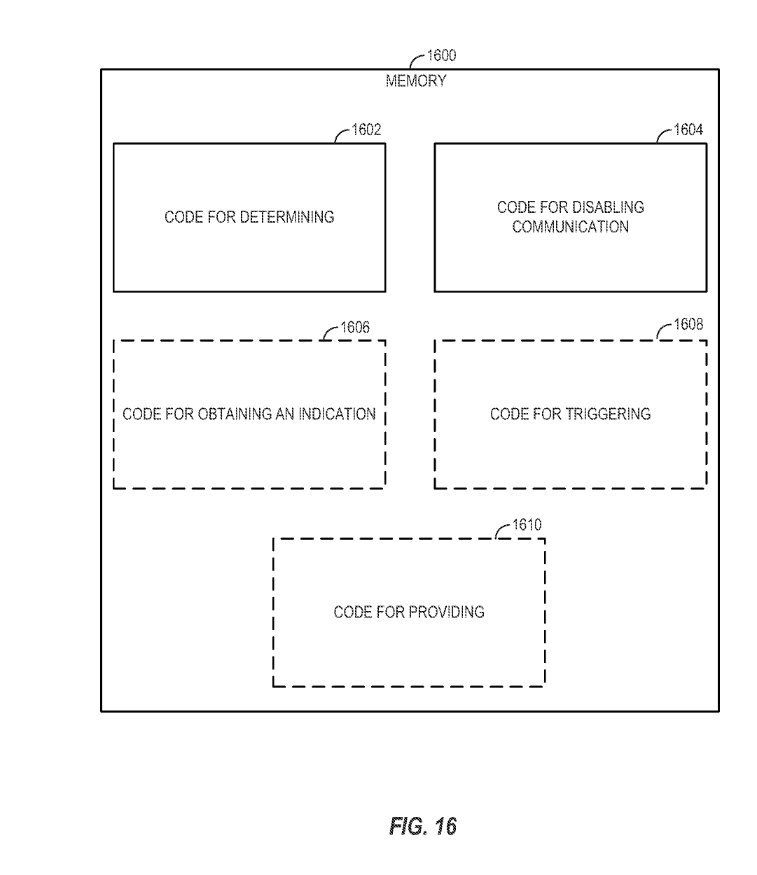

Referring to FIG. 16, programming stored by the memory 1602 (e.g. a storage medium, a memory device, etc.), when executed by a processing system (e.g., the processing system 1104 of FIG. 11), causes the processing system to perform one or more of the various functions and/or process operations described herein. For example, the programming, when executed by the processing system 1104, may cause the processing system 1104 to perform the various functions, steps, and/or processes described herein with respect to FIGS. 1, 5, and 12-14 in various implementations. As shown in FIG. 16, the memory 1600 may include one or more of code for determining 1602, code for disabling communication 1604, code for obtaining 1606, code for triggering 1608, or code for sending 1610. In some aspects, one of more of the code for determining 1602, the code for disabling communication 1604, the code for obtaining 1606, the code for triggering 1608, or the code for sending 1610 may be executed or otherwise used to provide the functionality described herein for the circuit for determining 1502, the circuit for disabling communication 1504, the circuit for obtaining 1506, the circuit for triggering 1508, or the circuit for sending 1510. In some aspects, the memory 1600 of FIG. 16 may correspond to the memory 1106 of FIG. 11. In some aspects, one or more of any components represented by dashed boxes in FIG. 16 may be optional.

### Additional Aspects

The examples set forth herein are provided to illustrate certain concepts of the disclosure. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

As those skilled in the art will readily appreciate, various aspects described throughout this disclosure may be extended to any suitable telecommunication system, network architecture, and communication standard. By way of example, various aspects may be applied to wide area networks, peer-to-peer network, local area network, other suitable systems, or any combination thereof, including those described by yet-to-be defined standards.

Many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

One or more of the components, steps, features and/or functions illustrated in above may be rearranged and/or combined into a single component, step, feature or function or embodied in several components, steps, or functions. Additional elements, components, steps, and/or functions may also be added without departing from novel features disclosed herein. The apparatus, devices, and/or components illustrated above may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The functions, methods, sequences or algorithms described in connection with the aspects disclosed herein may be embodied directly in hardware, in a software and/or firmware module executed by a processor, or in a combination thereof. An example of a storage medium is coupled to the processor such that the processor can read information from, and write information to, the storage medium. In the alternative, the storage medium may be integral to the processor.

If implemented in software and/or firmware, the functions, methods, sequences or algorithms may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EPROM, EEPROM, CD-ROM, registers, flash memory, or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

The terminology used herein is for the purpose of describing particular aspects only and is not intended to be limiting of the aspects. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “I” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may comprise one or more elements. In addition, terminology of the form “at least one of a, b, or c” or “a, b, c, or any combination thereof” used in the description or the claims means “a or b or c or any combination of these elements.” For example, this terminology may include a, or b, or c, or a and b, or a and c, or a and b and c, or 2a, or 2b, or 2c, or 2a and b, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated.

1. An apparatus for communication, comprising:
a processing system configured to:
determine whether radar detection is enabled, and
disable communication on at least one wireless communication channel if the determination indicates that radar detection is not enabled.

2. The apparatus of claim 1, wherein the at least one wireless communication channel is associated with a radar detection requirement.

3. The apparatus of claim 1, wherein, to determine whether radar detection is enabled, the processing system is further configured to:
provide a data pattern indicative of a radar signal for transmission to a component of the apparatus designated to perform a radar detection function; and
determine whether a response to the data pattern is received from the component.

4. The apparatus of claim 3, wherein:
the response comprises an indication of whether radar is present; and
the processing system is further configured to determine whether the radar detection is enabled based on the indication of whether radar is present.

5. The apparatus of claim 3, wherein the processing system is further configured to:
obtain an indication that the at least one wireless communication channel has been selected for communication; and
trigger the providing of the data pattern after obtaining the indication.

6. The apparatus of claim 3, wherein:
the component comprises a host software component of the apparatus; and
the data pattern is provided by a firmware component of the apparatus.

7. The apparatus of claim 3, wherein, to disable the communication on the at least one wireless communication channel, the processing system is further configured to block the component from using the at least one wireless communication channel.

8. The apparatus of claim 3, wherein the processing system is further configured to provide different data patterns indicative of different radar signals to the component over time.

9. The apparatus of claim 3, further comprising:
an interface to provide the data pattern to the component.

10. The apparatus of claim 3, wherein the data pattern comprises a spoofed data pattern.

11. The apparatus of claim 3, wherein, to provide the data pattern, the processing system is further configured to perform at least one of: provide the data pattern on a random basis, provide the data pattern on a periodic basis, provide the data pattern on an on-demand basis, provide the data pattern if Wi-Fi communication is enabled, provide the data pattern for a channel if the channel is in use, or any combination thereof.

12. The apparatus of claim 1, wherein, to disable the communication on the at least one wireless communication channel, the processing system is further configured to ignore a request to select the at least one communication channel.

13. The apparatus of claim 1, wherein, to disable the communication on the at least one wireless communication channel, the processing system is further configured to reject a request to select the at least one communication channel.

14. The apparatus of claim 1, wherein the at least one wireless communication channel comprises a dynamic frequency selection channel.

15. A wireless node, comprising:
a processing system configured to:
determine whether radar detection is enabled, and
disable communication on at least one wireless communication channel if the determination indicates that radar detection is not enabled; and
a transceiver coupled to the processing system to communicate data on the at least one wireless communication channel.

16. A method of communication, comprising:
determining whether radar detection is enabled; and
disabling communication on at least one wireless communication channel if the determination indicates that radar detection is not enabled.

17. The method of claim 16, wherein the at least one wireless communication channel is associated with a radar detection requirement.

18. The method of claim 16, wherein the determination comprises:
providing a data pattern indicative of a radar signal for transmission to a component of an apparatus, wherein the component is designated to perform a radar detection function; and
determining whether a response to the data pattern is received from the component.

19. The method of claim 18, wherein:
the response comprises an indication of whether radar is present; and
the determination of whether radar detection is enabled is based on the indication of whether radar is present.

20. The method of claim 18, further comprising:
obtaining an indication that the at least one wireless communication channel has been selected for communication; and
triggering the providing of the data pattern after obtaining the indication.

21-44. (canceled)
